(19) United States
(12) Patent Application Publication
(10) Pub. No.: US 2012/0043787 A1
(43) Pub. Date: Feb. 23, 2012

(54) SLIDING ROOF CONFIGURATION FOR A MOTOR VEHICLE

(75) Inventor: Marten WITTORF, Ingelheim (DE)

(73) Assignee: GM GLOBAL TECHNOLOGY OPERATIONS LLC, Detroit, MI (US)

(21) Appl. No.: 13/214,319

(22) Filed: Aug. 22, 2011

(30) Foreign Application Priority Data
Aug. 20, 2010 (DE) 102010034931.3

(51) Int. Cl. B60J 7/02

(52) U.S. Cl. 296/216.08

(57) ABSTRACT

A sliding roof configuration is provided for a motor vehicle having a roof frame structure, on which a cover is guided so it is displaceable between a closed position and an open position using opposing lateral guide devices. The spacing of the opposing guide devices changes in this case viewed in the displacement direction of the cover and a guide device has multiple guide rails, which each extend in the displacement direction of the cover, and are situated offset to one another in the displacement direction and diagonally or perpendicularly thereto, and which are each implemented to guide one associated sliding element.

### CROSS-REFERENCE TO RELATED APPLICATION

This application claims priority to German Patent Application No. 102010034931.3, filed Aug. 20, 2010, which is incorporated herein by reference in its entirety.

### TECHNICAL FIELD

The technical field relates to a sliding roof configuration for a motor vehicle having a roof frame structure, on which a cover or a sliding roof is guided so it is displaceable between a closed position and an open position using opposing lateral guide devices.

### BACKGROUND

Greatly varying sliding roof or sunroof configurations exist for motor vehicles. A displaceable cover, which can also be manufactured from glass or similar transparent materials in the case of sunroofs, is typically situated in this case in the vehicle longitudinal direction on the roof frame structure to at least regionally or completely expose an opening provided in the roof structure.

Under aesthetic aspects and in order to correspond to a predefined vehicle design, for example, the displaceable cover is to have the greatest possible width in the vehicle transverse direction and is to extend over nearly the entire width of the vehicle roof. However, such design specifications can only be implemented with great effort in roof frame structures implemented as tapered in the vehicle longitudinal direction.

In this context, for example, DE 102 01 636 B4 describes a sliding roof configuration in which the guide rails, which are situated along the lateral edges of a roof opening and are provided for the sliding roof cover, have a changing spacing to one another in the displacement direction of the cover. For example, the roof opening has a trapezoidal form. Corresponding to the changing spacing of the guide rails to one another, the sliding elements of the cover, which are guided in the guide rails, can execute a corresponding compensation movement transversely to the displacement direction, relative to the cover. However, the displaceability of the sliding elements relative to the cover proves to be complex with respect to design and installation and in long-term operation and the sliding roof configuration sometimes also proves to be failure-prone and high maintenance.

Therefore, at least one object is therefore to provide a sliding roof configuration which is as simple and low maintenance as possible, and for which a compensation mechanism is not required for the cover-side sliding elements, and provides a reduction in production and installation costs. In addition, other objects, desirable features and characteristics will become apparent from the subsequent summary and detailed description, and the appended claims, taken in conjunction with the accompanying drawings and this background.

### SUMMARY

The sliding roof configuration of a motor vehicle has a roof frame structure, on which a cover generally functioning as a sliding roof is guided so it is displaceable between a closed position and an open position using opposing lateral guide devices. The spacing of the opposing lateral guide devices changes in the displacement direction of the cover in this case. In particular, it is provided that the lateral edges of the opening formed in the roof frame structure extend at least sectionally at an angle in relation to the displacement direction of the cover. The roof opening which is provided in the roof frame structure and is closable using the cover can have a trapezoidal form, for example.

It is provided that at least one, preferably both guide devices have multiple guide rails and associated sliding elements which can be guided in the guide rails. A lateral guide device therefore has at least two guide rails which extend in the displacement direction of the cover, but, in the displacement direction of the cover and diagonally or perpendicularly thereto are situated offset to one another and are oriented parallel to one another. Each of the guide rails is implemented to guide one associated sliding element in each case.

It is particularly provided for this purpose that the guide rails each extend only sectionally and at an angle along the lateral edge of the roof opening. The guide rails of a guide device are situated stepped or cascaded to one another. Their configuration approximately follows the lateral edge of the roof opening. A corresponding number of sliding elements is associated with a number of guide rails of a guide device.

In the course of a displacement movement of the cover, one sliding element is at least temporarily engaged with an associated guide rail in each case. Since the affected guide rail does not extend over the entire length of the displacement path, the sliding element also disengages from the guide rail again in the course of the displacement movement. The guide of the cover on the guide device is then taken over by the guiding of a further sliding element in a further guide rail, however.

According to an embodiment, it is further provided in this case that at least two guide rails of a guide device are situated regionally overlapping one another in a projection transverse to the radial longitudinal direction. The respective sliding elements associated with the rails are preferably situated to one another diagonally or perpendicularly to the rail longitudinal direction in this case. In the course of a displacement movement, it is thus ensured that a first guide pair formed by sliding element and guide rail only disengages when a second guide pair, which is formed approximately correspondingly, engages with one another and takes over the further guiding of the cover on the roof frame structure. The overlapping configuration of the guide rail of one guide device provided transversely to the rail longitudinal direction thus provides a redundant guide in the transfer or transition area, in particular on the end sections of the guide rails in the displacement direction.

Furthermore, it is advantageous if at least two guide rails situated directly adjacent to one another are situated successively offset to one another, both in the rail longitudinal direction and also transversely or perpendicularly thereto. Such a stepped configuration of the guide rails can, for example, in the case of a trapezoidal roof opening provided with inclined lateral edges, sectionally provide a guide of the cover oriented in the displacement direction of the cover.

Furthermore, it is provided according to an embodiment that the respective sliding elements which can be engaged with the guide rails are situated spaced apart from one another, corresponding to the transverse offset of the respective associated guide rails among one another. The sliding elements are preferably situated on a rear end section in the opening direction or a front end section of the cover, in the closing direction of the cover. A configuration of the guide rails on the roof frame structure is provided corresponding to the cover-side configuration of the sliding elements.

A reverse configuration of guide rails and sliding elements can be implemented similarly in alternative embodiments, however. It is thus entirely conceivable to situate the sliding elements following the contour of the lateral edge of the roof opening, along the respective lateral edge, and to provide the guide rails which can be engaged therewith on the cover side, the guide rails being oriented parallel to one another in this case and being situated offset to one another and/or spaced apart from one another at least diagonally or perpendicularly to the displacement direction of the cover. An offset of the guide rails along the displacement direction would not fundamentally be required here.

According to an embodiment it is also provided that the guide rails and the sliding elements of a guide device are alternately situated on the cover and on the roof frame structure such that in the course of a displacement movement, such as an opening or closing movement of the cover, at least one sliding element is always engaged with a guide rail and first disengages when at least one further sliding element is engaged with a further guide rail. The sliding elements can preferably be situated approximately perpendicularly to the displacement direction on the cover in this case.

Furthermore, at least one sliding element is preferably mounted so it is movable essentially parallel to the surface normal of the cover against a pre-tension force. The sliding element can thus be provided with a spring pre-tension, for example, which pulls the sliding element into the cover in the case of an inactive sliding element, i.e., a sliding element located outside the guide rail, or reduces its extension perpendicular to the cover plane. In this way, any damage to the roof skin adjoining the roof opening can be avoided, for example, when the cover is transferred into the open position, in which it is located above the roof skin adjoining the roof opening, for example.

Furthermore, it can be provided that at least one guide rail, on an end section, has an inlet or outlet slope for the associated sliding element for raising and/or lowering the cover. Such an inlet or outlet slope can also contribute to transferring the sliding element into an extended position against a spring pre-tension, which allows a formfitting engagement of sliding element and guide rail. Furthermore, the inlet or outlet slope is preferably implemented for the purpose of, for example, at the beginning of an opening movement of the cover, at least slightly raising the cover in the vertical direction, in order to transfer it from a surface-flush configuration with the adjoining roof skin into a raised intermediate or open position, in which the cover is displaceable over the roof skin section adjoining the roof opening in the displacement direction.

According to an embodiment, the sliding roof configuration is provided with a middle guide, which extends between the two lateral and opposing guide devices regionally into the roof opening, at least in the closed position of the cover. The middle guide has a slide rail, for example, which protrudes at least regionally into the roof opening opposite to the opening direction. The middle guide is furthermore situated approximately centrally between the two lateral guide devices in this case.

According to another embodiment, it is further provided that the slide rail of the middle guide engaged with a middle sliding element of the cover is situated so it is movable on the roof frame structure in the displacement direction of the cover. The middle guide thus provides a third guide device for the cover in addition to the lateral guide devices, which is thus situated on three points, situated approximately in a triangle, so it is displaceable on the roof frame structure.

In that the slide rail of the middle guide is itself situated on the roof frame structure in the displacement direction of the cover, for example, in the course of an opening movement, the middle attachment point of the cover can be shifted further in the opening direction, so that a predefined minimum spacing in the displacement direction of the cover can be maintained between the middle guide point and the two lateral guide points. This is because sluggishness or tilting of the cover on the guide points would be a concern if the spacing fell below a minimum spacing.

In that the middle guide or support point for the cover is shifted in the opening direction, for example, during opening of the cover, a required minimum distance of the support points of the cover among one another can always be maintained and a triangular configuration of the support points, which is advantageous for the smooth running of the opening or closing movement, can be maintained.

In a further embodiment, it is also provided that the slide rail is mounted so it is pivotable on the roof frame structure both upward and also in the direction of the opening movement of the cover in the course of an opening movement of the cover. For example, the centrally situated guide rail can be pivoted or displaced using a joint configuration—in particular a multi-joint configuration—both in the displacement or opening direction and also in the vehicle vertical direction.

In a further embodiment, a flexible coating, which is slotted in the displacement area of the sliding element mounted so it is movable in the guide rail, is provided for the guide rail. Using the coating or a protective device provided with flexible bristles, the slide rail can be protected against contaminants. In addition, the coating or the protective device prevents the vehicle occupants from being able to grasp in the slide rail using their fingers and injure themselves, for example. Furthermore, it proves to be advantageous if the middle guide rail and/or the sliding element guided therein is coupled to a drive. In particular in the case of an embodiment in which the cover-side sliding elements are situated on an end section of the cover facing away from the opening direction, and the middle guide is provided on an end section of the cover facing toward the opening direction at least at the beginning of an opening movement, but opposite thereto, the lateral guide devices only function as a lateral guide, while a force provided for opening or closing the cover is introduced centrally into the cover.

According to an embodiment, it is further provided that an interior lighting device is situated on the slide rail, which protrudes at least regionally into the roof opening, facing toward the interior of the motor vehicle. For example, multiple illuminants can be situated along the slide rail, facing away from the cover and therefore downward and toward the vehicle occupants, which contribute to improved interior illumination. In addition, in a further independent aspect, the invention relates to a motor vehicle having an above-described sliding roof configuration.

### BRIEF DESCRIPTION OF THE FIGURES

The present invention will hereinafter be described in conjunction with the following drawing figures, wherein like numerals denote like elements, and:

FIG. 1 shows a simplified schematic view of the sliding roof configuration in the closed position;

FIG. 2 shows the configuration according to FIG. 1 in a partially open position;

FIG. 3 shows a schematic detail view of the sliding roof configuration with middle guide in the closed and open positions;

FIG. 4 shows a view according to FIG. 3 with additional force triangles shown;

FIG. 5 shows the sliding roof configuration according to FIG. 3 and FIG. 4 with a protective device provided on the middle guide;

FIG. 6 shows an exemplary cross-sectional view of a sliding element and its guide in a guide rail;

FIG. 7 shows a further variant of a sliding element and an associated guide rail;

FIG. 8 shows a sliding element, which is mounted so it is displaceable on the cover under spring force, in the base position and the extended position;

FIG. 9 shows a perspective view, with detail enlargement, of the guide rails on the roof frame structure side;

FIG. 10 shows a schematic view of the middle guide with closed cover;

FIG. 11 shows the middle guide according to FIG. 10 with open cover;

FIG. 12 shows a cross-sectional view of the middle guide in the closed position of the cover;

FIG. 13 shows a view of the cover, corresponding to FIG. 12, at the beginning of an opening movement;

FIG. 14 shows a cover displaced in the opening direction;

FIG. 15 shows a schematic interior view of the middle guide protruding into the roof opening; and

FIG. 16 shows the middle guide according to FIG. 15 with the auxiliary lighting turned on.

### DETAILED DESCRIPTION

The following detailed description is merely exemplary in nature and is not intended to limit application and uses. Furthermore, there is no intention to be bound by any theory presented in the preceding background or summmary or the following detailed description.

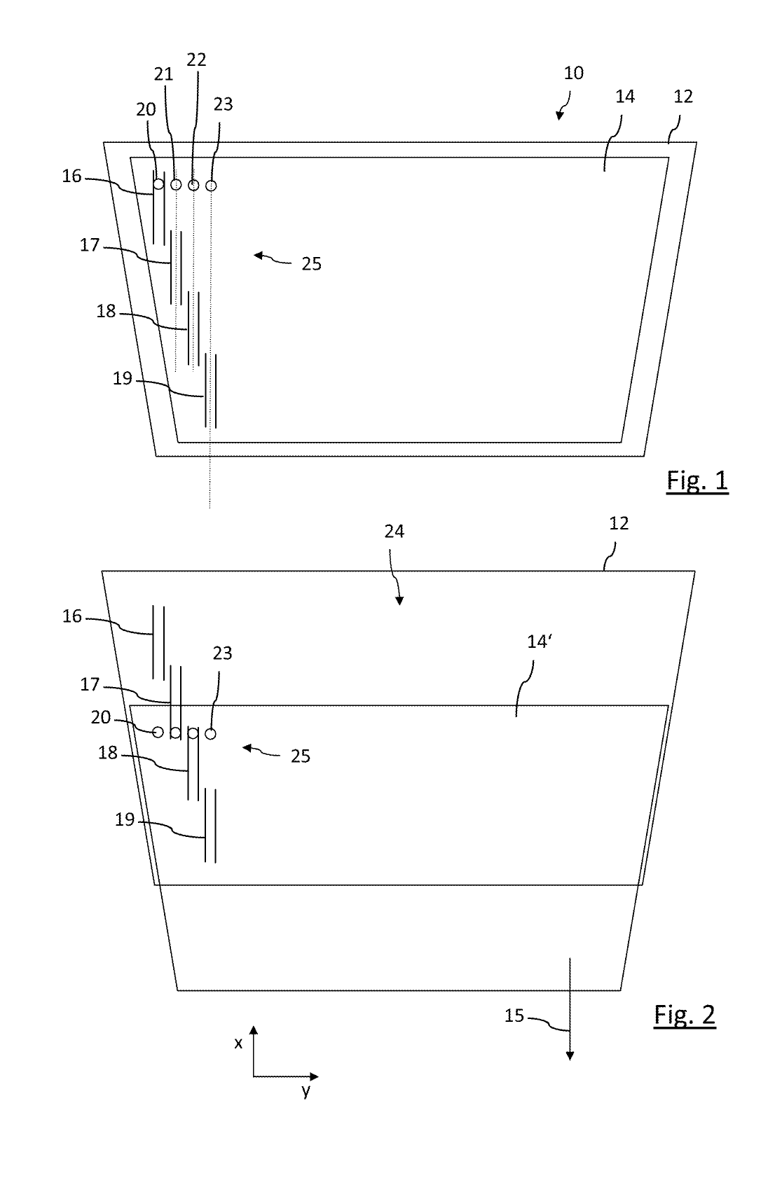

FIG. 1 and FIG. 2 show a schematic view of the mode of operation of the sliding roof configuration 10. It has a roof frame structure 12 and a cover 14, which is displaceable along a displacement direction 15 and functions as a sliding roof The roof frame structure, of which only an edge adjoining the roof opening 24 is shown can have nearly any arbitrary form in this case. However, the roof opening 24 implemented therein has a trapezoidal structure in the exemplary embodiment shown, the lateral edges shown on the left and right in FIG. 1 and FIG. 2 extending at an angle to the opening direction 15. A guide device 25 is formed on each of the lateral edges, of which only the guide device is shown and explained in greater detail in its mode of operation in FIG. 1 and FIG. 2.

For guiding the cover 14 on the roof frame structure 12, the guide device 25 has multiple guide rails 16, 17, 18, 19, as well as sliding elements 20, 21, 22, 23 respectively provided therefor. The guide rail 16, 17, 18, 19, which are preferably situated on the roof frame structure 12 and are located outside the roof opening 24, of course, are oriented along the displacement direction 15 of the cover 14. They are situated offset to one another both in the displacement direction 15 and also perpendicularly thereto, for example, in the vehicle transverse direction (y).

The configuration of guide rails 16, 17, 18, 19, which is cascaded and stepped in the top view shown in FIG. 1 and FIG. 2, is implemented so that in the course of a displacement movement of the cover 14 relative to the roof frame structure 12, at least one sliding element 20, 21, 22, 23 provided on the cover side is engaged with at least one of the guide rails 16, 17, 18, 19. The guide rails 16, 17, 18, 19 only extend partially along the lateral edges of the roof opening 24 in this case.

In addition, they are situated so they at least regionally overlap at their end sections in a projection transversely or perpendicularly to the rail longitudinal direction, so that in the course of a displacement movement of the cover, a further sliding element 21, 22, 23 is already engaged with a correspondingly provided guide rail 17, 18, 19, before a first pair, formed by sliding element 20 and associated guide rail 16, for example, disengages.

Therefore, in FIG. 1, only the outer sliding element 20 is engaged with a guide rail 16, which is also outer. In the course of a continuing opening movement of the cover 14, a second sliding element 21, which is situated offset in the transverse direction to the first sliding element 20, engages with a guide rail 17 situated correspondingly offset in the transverse direction. In the course of a continuing opening movement of the cover 14, the outer sliding element 20 and the associated guide rail 16 then disengage, as is clear in FIG. 2, for example. Furthermore, the transition or the transfer of the cover guide from the second guide pair 17, 21 to the third guide pair, formed by the sliding element 22 and guide rail 18, is shown therein.

The guide rails 16, 17, 18, 19 preferably extend approximately in the vehicle longitudinal direction (x). Viewed in the vehicle transverse direction (y), the guide rails 16, 17, 18, 19, which are situated adjacent to one another, overlap one another in a transition area on their longitudinal-side end sections, in order to allow a redundancy of the guiding of the sliding elements situated on the cover side, preferably spaced apart from one another in the vehicle transverse direction (y).

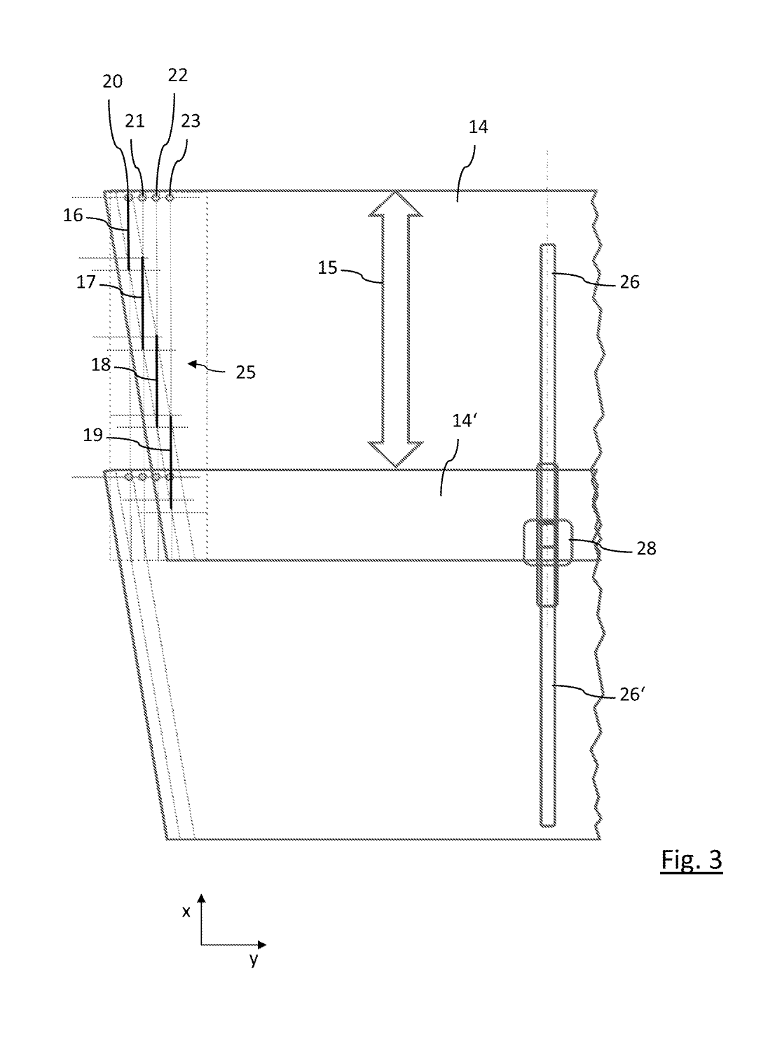

The left-side guide device 25 is shown in simplified and schematic form in the views of FIG. 3 to FIG. 5. For the sake of simplicity, the individual guide rail 16, 17, 18, 19 are symbolized by comparatively thick lines. FIG. 3 to FIG. 5 show an isolated view of only the cover 14, in each case both in the closed position and also in the open position 14′. In addition, a middle guide 26 is shown in FIG. 3 to FIG. 5, which has a slide rail 26 extending essentially in the displacement direction 15, which extends upward opposite to the opening direction 15, which is oriented downward in FIG. 3, of the cover 14, i.e., preferably forward in the vehicle longitudinal direction. The slide rail 26, or the middle guide formed thereby, only protrudes regionally in this case into the area of the roof opening 24 closable by the cover 14.

The slide rail 26 is advantageously mounted so it is movable on the roof frame structure 12 in the displacement direction of the cover. The slide rail 26 can thus together, or at least correlated with the opening movement of the cover 14, similarly be transferred into an end position 26′ displaced in the opening direction 15. The displaceability of the slide rail 26 along the displacement direction of the cover 14 allows the connection or guide points of the cover 14 on the roof frame structure 12 to remain as unchanged as possible in their relative position to one another during the opening and/or closing of the cover 14.

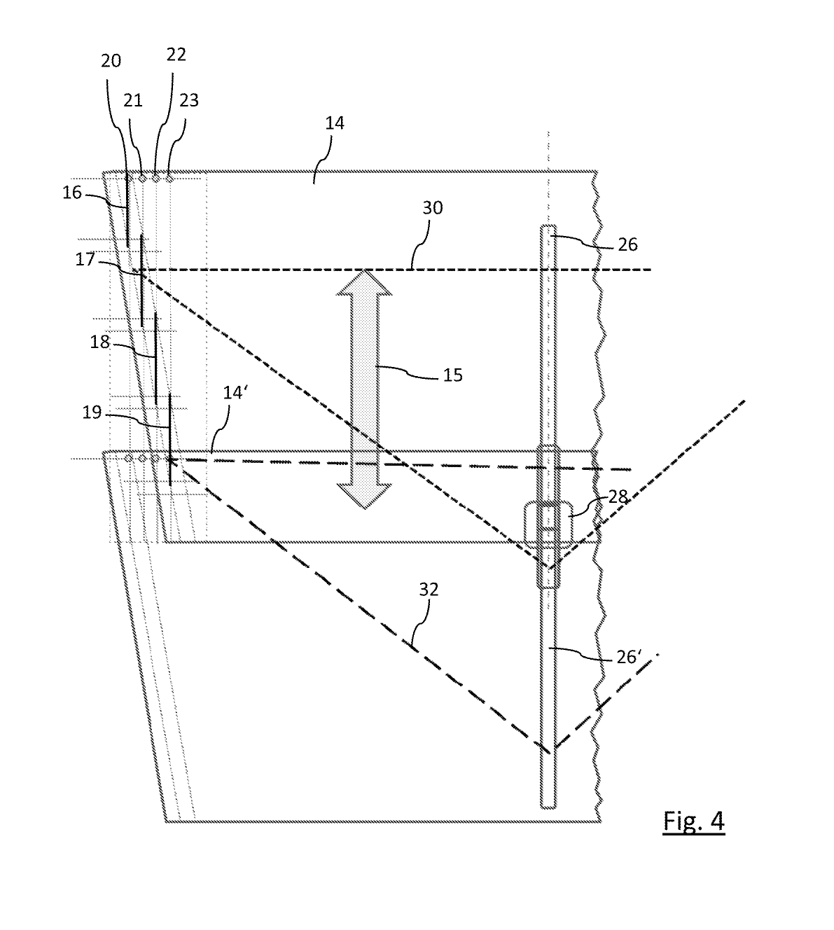

For example, if the cover 14 is transferred into the open position 14′ shown on the bottom of FIG. 4, the lateral contact points defined by the sliding elements 20, 21, 22, 23 thus travel similarly downward and to the rear, in the vehicle longitudinal direction. A displacement of the central contact point of the cover 14 predefined by the slide rail 26 similarly accompanies this displacement, so that the force triangle 30 formed by the lateral and the middle contact points also has an approximately uniform or only slightly changed structure 32, which hardly impairs the kinematics of the cover movement, upon reaching an open position. The opening or closing movement of the cover 14 can thus be performed substantially using a comparatively homogeneous and uniform force to be applied.

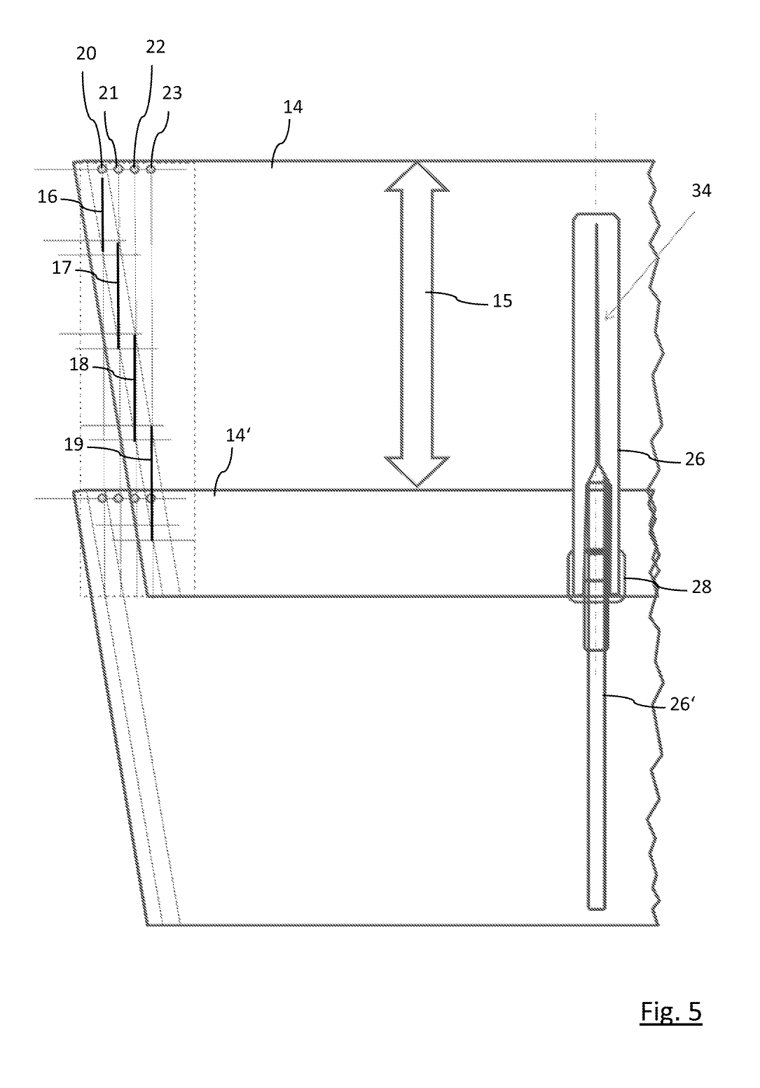

FIG. 5 schematically shows that the slide rail 26 is provided with a slotted coating 34, at least in the area protruding into the roof opening 24, which, on the one hand, allows guiding of an associated cover-side longitudinal guide 44 in the slide rail 26, but, on the other hand, is also to prevent the infiltration of contaminants and grasping of vehicle occupants in the rail.

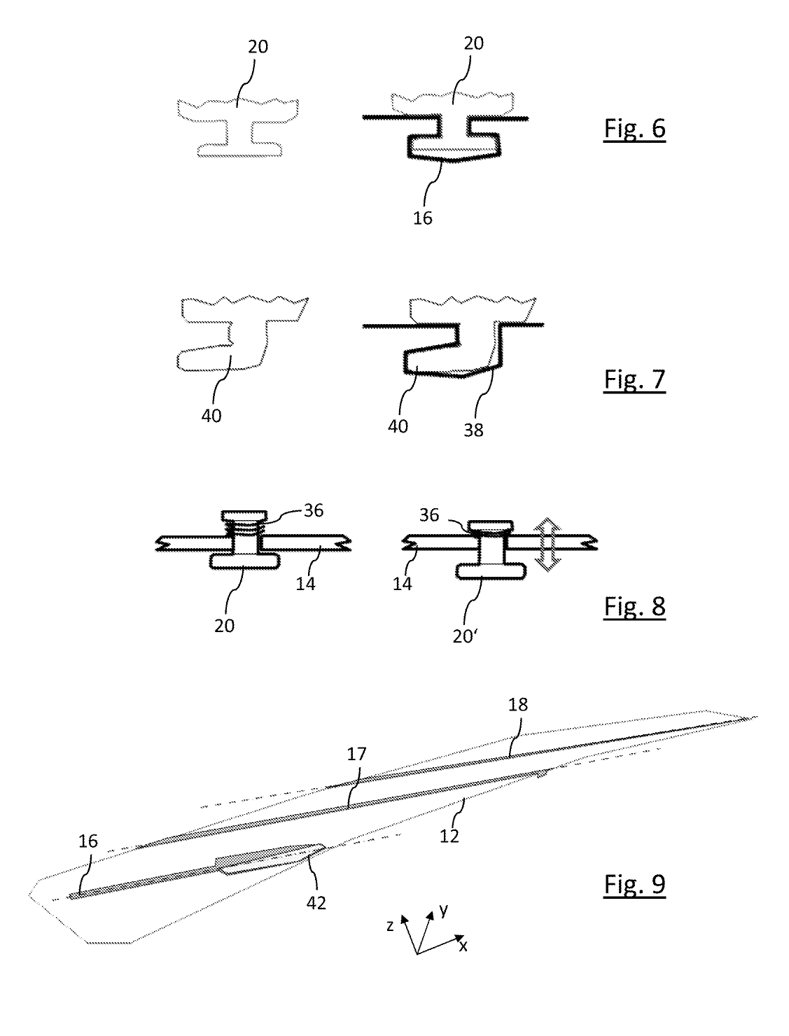

FIG. 6 shows an isolated view of a possible design of a sliding element 20, which is situated on the cover side, for example, and which can have a double-T structure, which allows formfitting guiding along a guide rail 16 formed correspondingly thereto in cross-section. Instead of a T-shaped design, FIG. 6 shows, in alteration thereof, a design of a sliding element 40 which is bent in one direction so it is approximately hooked or L-shaped, and an associated guide rail 38.

For example, FIG. 8 shows a sliding element 20 which is under a spring pre-tension 36 and is provided so it is displaceable on the cover 14. On an upper or inner side of the cover 14 facing away from the associated guide rail 16, a compression spring 38 is supported on one side on the cover 14 and on the other side on a widened upper end section of the sliding element 20, which attempts to displace the sliding element 20 vertically upward. With a design of guide rail 16 provided corresponding thereto, for example, having an inlet or outlet slope 42 as schematically shown in FIG. 9, the sliding element 20 can be inserted into the guide rail 16 and, while continuing movement therein, transferred into the downwardly deflected configuration as shown on the right in FIG. 8. The inlet or outlet slope 42, as schematically shown in FIG. 9, at the end of the external guide rail 16 can further contribute to raising the cover 14 in the vertical or vehicle vertical direction (z), in order to displace it above a roof skin section 46 adjoining the roof opening 24, in particular at the beginning of an opening movement.

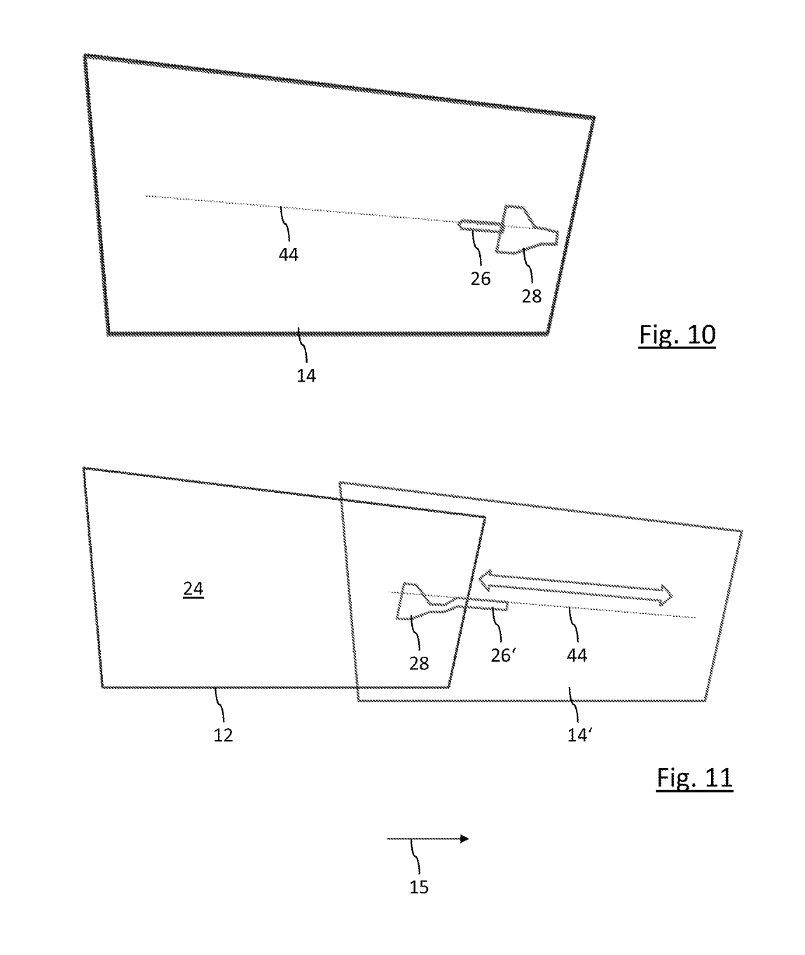

The displacement of the middle slide rail 26 in the course of an opening movement of the cover 14, 14′ is shown in a further schematic view in FIG. 10 and FIG. 11.

The slide rail 26, which protrudes to the left, into the later roof opening 24, in the closed position of the cover 14, is also displaced to the right, in the opening direction 15 of the cover 14′, upon transfer of the cover into the open position 14′ shown in FIG. 11. In addition, a longitudinal guide 44 corresponding to the slide rail 26 or a correspondingly formed sliding strand 44 of the cover 14 is shown in this case.

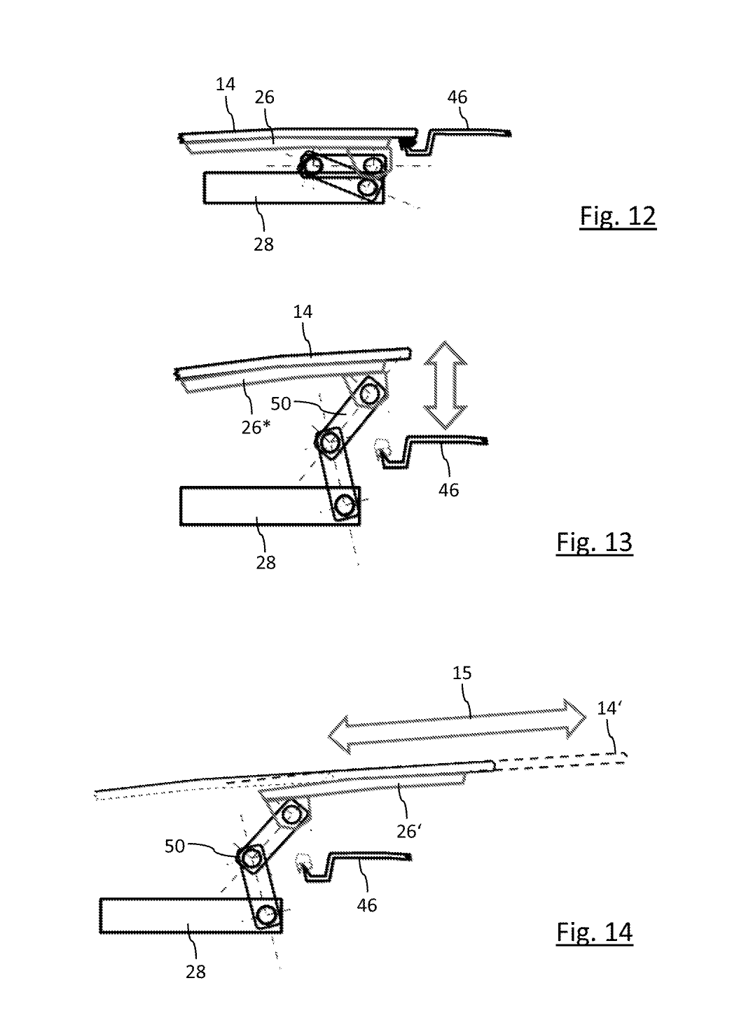

In the sequence of FIG. 12 to FIG. 14, an articulated mounting of slide rail 26 on the roof frame structure 12 is shown. The slide rail 26 is transferable in this case via a two-jointed joint configuration 50 both in the vehicle vertical direction (z) and also in the vehicle longitudinal direction (x) from a base position shown in FIG. 12 into an open position 26′ shown in FIG. 14. An intermediate position 26 is indicated in FIG. 13, in which the slide rail 26 having unfolded joint is only raised in relation to a mount 28, but not yet displaced over the adjoining roof skin 46 in the vehicle longitudinal direction (x).

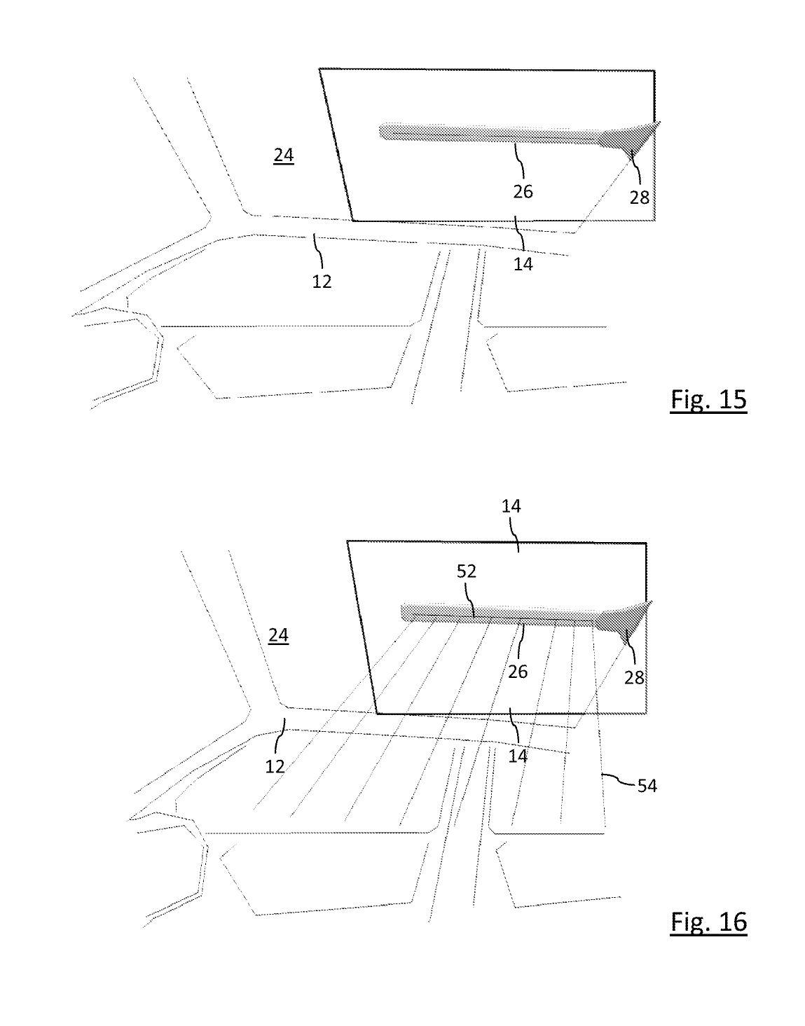

Furthermore, an interior view of the sliding roof configuration 10 having the middle guide 26, which protrudes from back to front at least regionally into the roof opening 24, is shown in a schematic view in FIG. 15 and FIG. 16. On its bottom side, facing toward the interior of the motor vehicle as schematically shown in FIG. 15 and FIG. 16, the slide rail 26, which is preferably provided with a protective coating, has a lighting device 52 having at least one, preferably multiple illuminants situated along the slide rail 26, which can generate a light cone 54 to illuminate the vehicle interior if needed.

While at least one exemplary embodiment has been presented in the foregoing summary andn detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

What is claimed is:

1. A sliding roof configuration for a motor vehicle, comprising:
a cover;
opposing lateral guide devices;
a roof frame structure on which the cover is guided using the opposing lateral guide devices so the roof frame structure is displaceable between a closed position and an open position, a spacing of the opposing lateral guide devices changes in a displacement direction of the cover; and
a guide device comprising a plurality of guide rails that extend in the displacement direction and situated offset to one another in the displacement direction and substantially diagonally thereto and oriented substantially parallel to one another, and which are each formed to guide an associated sliding element.

2. The sliding roof configuration according to claim 1, wherein at least two guide rails of the plurality of guide rails that regionally overlap one another in a projection transverse to a rail longitudinal direction.

3. The sliding roof configuration according to claim 1, wherein at least two guide rails of the plurality of guide rails that are situated directly adjacent to one another are situated successively offset to one another both in a rail longitudinal direction and also transversely thereto.

4. The sliding roof configuration according to claim 1, wherein at least two guide rails of the plurality of guide rails that are situated directly adjacent to one another are situated successively offset to one another both in a rail longitudinal direction and also perpendicularly thereto.

5. The sliding roof configuration according to claim 1, wherein a plurality of sliding elements, which can each be engaged with the plurality of guide rails, are situated spaced apart from one another on the cover corresponding to a transverse offset of respective associated guide rails.

6. The sliding roof configuration according to claim 1, wherein the plurality of guide rails is situated on the roof frame structure adjoining a roof opening.

7. The sliding roof configuration according to claim 1, wherein the plurality of guide rails and a sliding element are situated to one another such that during a movement of the cover, the sliding element is engaged with a guide rail, and first disengages when at least one further sliding element is engaged with a further guide rail.

8. The sliding roof configuration according to claim 1, wherein at least one sliding element is mounted to move in essentially parallel to a surface normal of the cover against a pre-tension force.

9. The sliding roof configuration according to claim 1, wherein at least one guide rail comprises one end section, a slope for the associated sliding element configured to move the cover.

10. The sliding roof configuration according to claim 1, further comprising a middle guide between two lateral and opposing guide devices, comprising a slide rail protruding regionally into a roof opening at least in the closed position of the cover.

11. The sliding roof configuration according to claim 10, wherein the slide rail, which is engaged with a middle sliding element of the cover, is situated to move on the roof frame structure in the displacement direction of the cover.

12. The sliding roof configuration according to claim 10, wherein the slide rail is mounted on the roof frame structure so that, during an opening movement of the cover, the roof frame structure is configured to pivot both upward and also in a direction of the opening movement of the cover.

13. The sliding roof configuration according to claim 7, wherein a slide rail comprises a flexible coating that is slotted in a displacement area of the sliding element.

14. The sliding roof configuration according to claim 10, wherein the slide rail is coupled to a drive.

15. The sliding roof configuration according to claim 13, wherein the sliding element guided therein is coupled to a drive.

16. The sliding roof configuration according to claim 10, wherein an interior lighting device is situated on the slide rail, which protrudes at least regionally into the roof opening.
